(19) United States
(12) Patent Application Publication
(10) Pub. No.: US 2020/0195898 A1
(43) Pub. Date: Jun. 18, 2020

(54) DISAPPEARANCE MAGIC SYSTEM

(71) Applicant: AHMAD ABO ALSHEGHRI, MONTREAL (CA)

(72) Inventor: Ahmad Abo Alsheghri, Montreal (CA)

(21) Appl. No.: 16/658,111

(22) Filed: Oct. 20, 2019

(30) Foreign Application Priority Data
Oct. 22, 2018 (CA) 3021736

(51) Int. Cl. H04N 9/31; A41F 9/00; H04N 5/225; H04N 5/247; F41H 3/00

(52) U.S. Cl. CPC H04N 9/3147; A41F 9/00; F41H 3/00; H04N 5/247; H04N 5/2253

(57) ABSTRACT

Our Disappearance magic system will enable any person to disappear in front of other people eyes.

Through the whole history it was magic for a person to disappear but with the new technology Not anymore.

Our magic system will enable any person to disappear in front of other people eyes.

It consists of two devices on one belt to be worn by a person, one device on the front side of the belt and the second on the back Side of the belt, the one on the back side has a camera captures the back view 180 degrees and send the rear view continuously to the front device (hologram projector)through the belt, the front device will be a hologram projector or another device projector to produce two or three dimensions image 180 degrees of the rear view to be in front of the person so the person will be hidden behind the Image that the device producing and the observer will not notice the person existence because He sees the image of the view behind the person as normal as the person is not there, also the system will hide the back side of the person by using same technic in reverse where other camera will be on the front side and the projector device on the back side of the belt, the two or three dimensions image will be produced as curve shape 180 degrees to hide the person not only from The front and the back side but also from the sides.

This system can be turned on when needed by pressing one button on the belt.

Also in same way to cover the top view of the person we will have a helmet with hologram projector toward the sky connected to camera on the belt capturing the ground view so the user will be hidden from people standing at high places or from air planes

This system can be used for military purposes.

The Second way off getting hidden consists of suit covers all the body with the head, on this suit there are two cameras one on the front side and the second on the back side, this suit will be made of special material to work as screen where the front camera will send the front view continuously to the back side of the Suit and the rear camera will send the rear view continuously to the front side of the suit so The person who wear the suit will be invisible from all sides where the observer from all sides Will see only the image of the opposite side view of the person who wears the suit. This system can be turned on when needed by pressing one button on the suit.

This system can be used for military purposes.

The third way of getting hidden consists of curved screen as a shield with cameras on both top rear ends of it, and any person behind this screen will be invisible from front and the sides where The cameras will capture the rear and side views and send it continuously to the screen where the observer will see on the screen only the back and side images of the view which is behind the screen as nobody is there.

This system can be turned on when needed by pressing one button on the screen.

This system can be used for military purposes.

The forth way of getting hidden consists of camera on the back of the person hold with belt and light curved screen as a shield to hide behind it where the rear cameras will capture the rear View and send it continuously to the screen by wire from the belt or wirelessly where the observer will see only the image of the opposite view as nobody is there.

This system can be turned on when needed by pressing one button on the belt.

This system can be used for military purposes.

“the embodiments of the invention in which an exclusive property or privilege is claimed are defined as follows:”

1.-2. (canceled)

3. Our magic system will enable any person to disappear and become invisible.
It consists of curved screen as a shield with cameras on both top rear ends of it, and any person behind this screen will be invisible from front and the sides where The cameras will capture the rear and side views and send it continuously to the screen where the observer will see on the screen only the back and side images of the view which is behind the screen as nobody is there. Or it is a camera on the back of the person held with belt and light curved screen as a shield To hide behind it where the rear cameras will capture the rear View and send it continuously to The screen by wire from the belt or wirelessly where the observer will see only the image of the back view which is behind the screen as nobody is there.
This system can be turned on when needed by pressing one button on the screen.
This system can be used for military purposes.

4.-5. (canceled)

6. Our magic system will enable any person to disappear in front of other people eyes. It consists of two devices on one belt to be worn by a person, one device on the front side of the belt and the second on the back Side of the belt, the one on the back side has a camera captures the back view 180 degrees and send the rear view continuously to the front device (hologram projector)through the belt, the front device will be a hologram projector or another device projector to produce two or three dimensions image 180 degrees of the rear view to be in front of the person so the person will be hidden behind the Image that the device producing and the observer will not notice the person existence because He sees the image of the view behind the person as normal as the person is not there, also the system will hide the back side of the person by using same technic in reverse where other camera will be on the front side and the projector device on the back side of the belt, the two or three dimensions image will be produced as curve shape 180 degrees to hide the person not only from The front and the back side but also from the sides.
Or we can have four cameras and four projectors on the belt to cover the four sides of the person instead of two cameras and two projectors

7. Our magic system will enable any person to disappear and become invisible. it consists of suit covers all the body with the head ,on this suit there are four cameras one on each side of the suit, this suit will be made of special material to work as screen where the front camera will send the front view continuously to the back side of the Suit and the rear camera will send the rear view continuously to the front side of the suit and likewise the cameras on the sides so The person who wear the suit will be invisible from all sides where the observer from all sides
Will see only the image of the back view of the person who wears the suit.
This system can be turned on when needed by pressing one button on the suit.
This system can be used for military purposes.
Also in same way to cover the top view of the person we will have a helmet with hologram projector toward the sky connected to camera on the belt capturing the ground view so the user will be hidden from people standing at high places or from air planes
This system can be turned on when needed by pressing one button on the belt.
This system can be used for military purposes.
